(19) United States
(12) Patent Application Publication
(10) Pub. No.: US 2008/0033129 A1
(43) Pub. Date: Feb. 7, 2008

(54) Polymeric viscosity modifiers

(75) Inventors: Lee Arnold Schechtman, Fairfield, OH (US); Joseph Jay Kemper, Cincinnati, OH (US); Giovanni Carlucci, Chieti (IT)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/888,436

(22) Filed: Aug. 1, 2007

Related U.S. Application Data
(60) Provisional application No. 60/834,863, filed on Aug. 2, 2006.

(51) Int. Cl. C08F 120/06; C08F 120/56

(52) U.S. Cl. 526/217; 526/262; 526/307.6; 526/312; 526/317.1; 526/318.2; 526/318.3

(57) ABSTRACT

Cross-linked ampholytic polymers that may be used as rheological modifiers, and/or absorbent gelling materials are disclosed. The polymers may be storage stable in aqueous compositions comprising soluble salt, and/or an oxidizer, such as hydrogen peroxide.

### CROSS REFERENCE TO RELATED APPLICATIONS

This application claims the benefit of U.S. Provisional Application No. 60/834,863, filed Aug. 2, 2006.

### FIELD OF THE INVENTION

Polymeric viscosity modifiers.

### BACKGROUND OF THE INVENTION

Polymeric viscosity modifiers (PVMs) or “thickeners” find use in a variety of compositions. For example, PVMs are used to thicken cosmetics, toiletries, coatings, paints, detergents, foods, motor oils and the like. A suitable PVM for use in thickening a specific composition may be chosen based upon factors including its performance and/or stability in that composition.

A PVM's performance and/or stability may be affected by conditions in a composition, such as pH, temperature and salt concentration. Consequently, a PVM that provides substantial thickening under the conditions in one composition may not be an effective thickener, or may even be unstable, under the conditions in another composition. It can therefore be important to incorporate a PVM having a chemical structure that is compatible with, and effectively thickens, an intended product composition under the conditions of its manufacture, storage and use.

The presence of substances including, but not limited to, oxidizers and salt may provide for conditions that can be harsh to PVMs. For example, hydrogen peroxide and carbonates are contained in the hair coloring and bleaching compositions described in co-filed U.S. Patent Application Ser. No. 60/834,867, wherein the compositions have low viscosity under low pH storage conditions, but that effectively thicken at higher, in-use pHs. Consequently, there is a need for PVMs that have improved performance in the presence of oxidizers and/or soluble salt over a wide range of storage and use conditions. It is further desirable to provide PVMs that are storage stable in the presence of hydrogen peroxide, and that thicken when they have a net charge. It is also desirable to provide PVMs and compositions comprising PVMs that are useful in hair colorants. It is further desirable to provide PVMs that have these characteristics without necessarily requiring the use of stability enhancers.

### SUMMARY OF THE INVENTION

Cross-linked ampholytic polymers that may be utilized as PVMs are presently disclosed. In one embodiment, the cross-linked ampholytic polymers comprise monomeric units derived from monomers selected from each of the following monomer types: polyfunctional cross-linking agents; anionic monomers; and cationic monomers. In one embodiment, the cross-linked ampholytic polymers have the following characteristics: storage stability for at least about 80 days at 40 degrees centigrade (° C.) in an aqueous dispersion comprising about 12 weight % of H₂O₂; and a net charge of 0 in an aqueous dispersion comprising a continuous phase at a pH within the inclusive range of from 2.0 to 6.0.

In another embodiment, the cross-linked ampholytic polymers comprise monomeric units derived from monomers selected from each of the groups consisting of:
a. polyfunctional cross-linking agents selected from the group consisting of: 1,3-diallylurea; triallylurea; tetraallylurea; and monomers having formula (I):

N⁺(R₁R₂R₃R₄)A⁻ (I)
wherein:
1) R₁, R₂, R₃, and R₄ each have formula (II):

[(CH₂)ₙCH═CH₂] (II)
wherein n is an integer from 1 to 3 and is independently chosen for each of: R₁; R₂; R₃; and R₄; and
2) A⁻ is an anion derived from organic or inorganic acids
b. anionic monomers; and
c. cationic monomers.

The anionic monomers (b) may be selected from the group consisting of: acrylic acid; methacrylic acid; maleic acid; fumaric acid; crotonic acid; and itaconic acid.

The cationic monomers (c) may be selected from the group consisting of: 3-acrylamidopropyltrimethylammonium salt; diallyldimethylammonium salt; [(3-methylacrylolyamino)propyl]trimethylammonium salt; 3-methyl-1-vinylimidizolium salt; [2-(acryloyloxy)ethyl]trimethylammonium salt; and [2-(acryloyloxy)propyl]trimethylammonium salt.

In another embodiment, a method of increasing the viscosity of an aqueous solution is disclosed. The method comprises the step of adding a presently disclosed cross-linked ampholytic polymer to the aqueous solution.

In a further embodiment, a personal care absorbent article comprising a present cross-linked ampholytic polymer is disclosed. When the cross-linked ampholytic polymer is in contact with at least one aqueous fluid, the polymer absorbs at least a portion thereof.

In yet another embodiment, a cleansing composition, such as an automatic liquid dishwashing detergent, a light duty liquid dishwashing detergent, a liquid laundry detergent, or a liquid hard surface cleaner, comprising a present cross-linked ampholytic polymer is disclosed.

These and other embodiments, aspects, and advantages are encompassed within the present invention, and will become better understood with regard to the following description and appended claims.

### DETAILED DESCRIPTION

“Ampholytic” and “amphoteric” may be used interchangeably, and describe a polymer that comprises anionic monomeric units and cationic monomeric units. An ampholytic polymer may be: anionic at a pH that is higher than its isoelectric point; and cationic at a pH that is lower than its isoelectric point; wherein the isoelectric point is the pH at which the net charge on a polymer is zero.

“Net charge” as used herein refers to the sum of the electric charges of the monomeric units comprising a polymer. The net charge of ampholytic and other ionic polymers may be dependant upon conditions including, but not limited to the pH, temperature and soluble salt concentration of the carrier containing the polymers, such as the continuous phase of an aqueous dispersion.

“Monomer” as used herein refers to a molecule that may be capable of reacting to form polymers by chemical union with monomers such as itself, or other monomers or monomeric units. “Monomeric unit” as used herein refers to a chemically bound unit in a polymer that is derived from a monomer.

“Cross-linked” as used herein refers to at least two chains of polymers attached by bridges, referred to herein as “cross-linking agents” comprising an element, a group, or a compound which joins certain carbon atoms of the chains by primary chemical bonds. “Polyfunctional” cross-linking agents may comprise monomers having: at least two double bonds; at least a double bond and a reactive group; or at least two reactive groups.

“Composition” as used herein may encompass the terms: dispersion, solution, melt (such as of a pure liquid substance), or fluid. “Dispersion” as used herein refers to a system of particles that may be evenly distributed in a medium, which is in turn referred to herein as the “continuous phase”. The term “aqueous dispersion” as used herein may comprise a dispersion of particles (which may comprise the present ampholytic polymers) distributed in a continuous phase comprising water.

“Rheology” as used herein refers to the deformation and flow characteristics of a visco-elastic fluid under the influence of an applied stress. “Rheological modifier” as used herein refers to a material or composition that is capable of changing the aforementioned deformation and flow of a visco-elastic fluid.

“Viscosity” as used herein refers to the resistance of a fluid to flow due to a shearing force. The viscosity of a fluid may be dependent upon the conditions under which it is measured, such as fluid temperature.

“Comprising” as used herein means that various components, ingredients or steps can be conjointly employed in practicing the present invention. Accordingly, the term “comprising” encompasses the more restrictive terms “consisting essentially of” and “consisting of”. The present compositions can comprise, consist essentially of, or consist of any of the required and optional elements disclosed herein.

Markush language as used herein encompasses combinations of the individual Markush group members, unless otherwise indicated.

All percentages, ratios and proportions used herein are by weight percent of the composition, unless otherwise specified. All average values are calculated “by weight” of the composition or components thereof, unless otherwise expressly indicated.

Mole percent (mol %) as used herein may mean either the percent of a monomeric unit in relation to all monomeric units of the polymer; or the mole fraction of reagents or reactants based upon other reagents or reactants.

All numerical ranges disclosed herein, are meant to encompass each individual number within the range and to encompass any combination of the disclosed upper and lower limits of the ranges.

Storage stable ampholytic polymers that may be used as PVMs in compositions comprising oxidizers are disclosed; a non-limiting example of an oxidizer is H₂O₂. The present polymers may have stability under these conditions regardless of whether stabilizers known in the art are also present in the composition. Stabilizers known in the art include, but are not limited to: sodium stannate, sodium pyrophosphate, butylated hydroxytoluene and other radical scavengers and chelants. Within the present context, “storage stable” describes a polymer that retains at least about 50%, at least about 75%, at least about 95%, or about 100% of its ability to thicken under “storage conditions” for the purposes of the disclosed “storage stability test” for at least 80 days, at least 90 days, or at least 100 days. As used herein, a polymer is under “storage conditions” when it is present in an aqueous dispersion comprising an aqueous continuous phase, and 12% of H₂O₂, at a temperature of 40° C.

Storage stable cross-linked ampholytic polymers are prepared using methods known in the art including, but not limited to, inverse suspension polymerization and solution polymerization of monomers. The storage stable ampholytic polymers may have the ability to withstand hydrolytic degradation and/or oxidation in an aqueous dispersion under storage conditions. The storage stable ampholytic polymers may have pH dependent thickening performance. Without wishing to be bound by theory, the polymers may swell and absorb liquid at a pH below the polymer's isoelectric point and above the polymer's isoelectric point.

Monomeric units of use in the present invention may be derived from monomers selected from the group consisting of: (1) polyfunctional cross-linking agents; (2) anionic monomers; and (3) cationic monomers.

Polyfunctional Cross-Linking Agents

Storage stable ampholytic polymers according to the present invention comprise polyfunctional cross-linking agents.

Polyfunctional cross-linking agents of use in the polymers of the present invention include the following non-limiting list of monomers: 1,3-diallylurea (DAU), triallylurea, tetraallylurea, N,N-diallylacrylamide (DAAm) and a monomer having formula (I):

N⁺(R₁R₂R₃R₄)A⁻ (I)

wherein R₁, R₂, R₃, and R₄ each have the formula (II):

[(CH₂)ₙCH═CH₂] (II)

Further wherein n may be an integer from 1 to 3 and may be independently chosen for each of R₁, R₂, R₃, and R₄. A⁻ may be an anion derived from organic or inorganic acids; non-limiting examples include: chloride, alkyl sulfates and half an equivalent of sulfates.

Tetraallylammonium chloride (TAAC), tetraallylammonium sulfate and tetraallylammonium methylsulfate are non-limiting examples of suitable monomers having formula (I).

Anionic Monomers

Storage stable ampholytic polymers according to the present invention further comprise monomeric units that may be derived from anionic monomers. Suitable anionic monomers may have the following general formula (III):

R₅—CH═CR₆—CO—OH (III)

wherein:
(a) R₅ is independently selected from the group consisting of: a hydrogen atom; a methyl radical; a COOH group; and a CH₂COOH group; and
(b) R₆ is independently selected from the group consisting of: a hydrogen atom; a methyl radical; a CH₂COOH group; and a CH₂CH₂COOH group.
   Non-limiting examples of suitable anionic monomers having the general formula (III) include: acrylic acid (AA); methacrylic acid (MAA); maleic acid; fumaric acid; crotonic acid; and itaconic acid.

Cationic Monomers

Ampholytic polymers according to the present invention further comprise cationic monomeric units. Suitable cationic monomeric units may be derived from monomers selected from the group consisting of: diallyldimethylammonium salt; 3-methyl-1-vinylimidazolium salt, and monomers having formula (IV):

R₇—CH═CR₈—CO—Y—(CₘH₂ₘ)—N⁺(R₉R₁₀R₁₁)A⁻ (IV)

wherein:
(a) R₇ and R₈ are each independently selected from the group consisting of: a hydrogen atom, and a methyl radical;
(b) Y is selected from the group consisting of: an NH group; an NR₁₂ group, wherein R₁₂ is an alkyl group having from 1 to 6 carbon atoms; and an oxygen atom;
(c) m is an integer from 2 to 5;
(d) R₉, R₁₀ and R₁₁ are each independently selected from the group consisting of linear and branched alkyl radicals having from 1 to 6 carbon atoms; and
(e) A⁻ is an anion selected from anions derived from organic or inorganic acids.

Non-limiting examples of A⁻ include: chloride, alkyl sulfates and half an equivalent of sulfate.

Non-limiting examples of suitable cationic monomers include: 3-acrylamidopropyltrimethylammonium chloride (APTAC), diallyldimethylammonium chloride (DADMAC), [(3-methylacrylolyamino)propyl]trimethylammonium chloride (MAPTAC), 3-methyl-1-vinylimidazolium chloride (QVI); [2-(acryloyloxy)ethyl]trimethylammonium chloride and [2-(acryloyloxy)propyl]trimethylammonium chloride.

Cross-Linked Ampholytic Polymers

To obtain storage stability and/or pH dependent swelling, the polyfunctional cross-linking agents, anionic monomeric units, and cationic monomeric units may be present in the disclosed polymers in any combination or molar ratio, so long as the properties of storage stability, and thickening in the presence of soluble salt is achieved. One of ordinary skill in the art would be able to customize the polymers to meet the desired properties and requirements.

The cross-linked ampholytic polymers of the present invention may be represented by the following formula (V):

LₓA_{y}C_{z} (V)

wherein: X, Y and Z are integers indicating the relative molar ratio of: polyfunctional cross-linking agents, “L”; anionic monomeric units “A”; and cationic monomeric units, “C”. Y may be greater in numerical value than Z and Z may be greater in numerical value than X, for the cross-linked ampholytic polymers of the present invention to have a net charge of 0 in an aqueous dispersion comprising a continuous phase at a pH within the inclusive range of from 2.0 to 6.0.

When the cross-linked ampholytic polymers of the present invention have a net charge of 0 (at their isoelectric point), they may be unswollen in the aqueous dispersion, and may provide little, if any, thickening. Upon acquisition of a net negative or positive charge, the polymers may swell in the aqueous dispersion, and may provide thickening. Typically, the cross-linked ampholytic polymers of the present invention acquire a net negative or net positive charge when the pH of the continuous phase of the dispersion is changed by at least about 1.0 or greater, at least about 0.5 or greater, or at least about 0.25 or greater pH units from the pH at which the net charge of the polymer is 0.

The polyfunctional cross-linking units may be present in the disclosed polymers at a minimum mole percentage of at least about 0.01 or greater, at least about 0.05 or greater or at least about 0.1 mol % or greater, and at a maximum mole percentage of about 5 or less, about 10 or less, or about 15 mol % or less.

The anionic monomeric units may be present in the disclosed polymers at a minimum mole percentage of at least about 51 or greater, at least about 60 or greater, or at least about 65 mol % or greater, and at a maximum mole percentage of at most about 75 or less, at most about 80 or less, or at most about 90 mol % or less.

The cationic monomeric units may be present in the disclosed polymers at a minimum mole percentage of at least about 5 or greater, at least about 10 or greater, at least about 15 or greater, or at least about 25 mol % or greater, and at a maximum mole percentage of at most about 30 or less, at most about 40 or less or about 49 mol % or less.

The disclosed cross-linked ampholytic polymers may swell in an aqueous solution in the presence of soluble salt in concentrations as low as 0.5 or greater, 1.0 or greater, or 5.0 weight % or greater, to concentrations as high as 30 or less, 20 or less, or 10 weight % or less. The property of swellability in the presence of water may make the present polymers useful as absorbent gelling materials as well as thickeners in compositions including, but not limited to: hair coloring and bleaching compositions; and cleaning compositions such as liquid dish detergents, liquid laundry detergents and liquid hard surface cleaners.

Compositions

Compositions according to the present invention may comprise, or may be used in combination with a composition that comprises, at least one source of an oxidizing agent. Oxidizing agents of use may include water-soluble peroxygen oxidizing agents. “Water-soluble” as defined herein means that at the temperature of storage or at ambient room temperature (e.g., 25° C.) at least about 1 gram (g), at least about 10 g, or at least about 100 g of the oxidizing agent can be dissolved in 1 liter (L) of deionized water or in the intended composition. In hair coloring and bleaching compositions, the oxidizing agents may be valuable for the initial solubilization and decolorization of the melanin (bleaching) and accelerate the oxidation of the oxidative dye precursors (oxidative dyeing) in the hair shaft.

Any water-soluble oxidizing agent known in the art may be utilized in the present invention. Water-soluble oxidizing agents may include inorganic peroxygen materials capable of yielding hydrogen peroxide in an aqueous solution. Suitable water-soluble peroxygen oxidizing agents known in the art include, but are not limited to: hydrogen peroxide, inorganic alkali metal peroxides such as sodium periodate and sodium peroxide, and organic peroxides such as urea peroxide, melamine peroxide, and inorganic perhydrate salt bleaching compounds, such as the alkali metal salts of perborates, percarbonates, perphosphates, persilicates, persulphates and the like. The inorganic perhydrate salts may be incorporated as monohydrates, tetrahydrates etc. Alkyl and aryl peroxides, and/or peroxidases may also be used. Mixtures of two or more oxidizing agents may be used if desired. The oxidizing agents may be provided in an aqueous solution or as a powder which is dissolved prior to use. Of particular use in the compositions according to the present invention are: hydrogen peroxide, percarbonate (which may be used to provide a source of both oxidizing agent and carbonate ions), persulphates and combinations thereof.

The cross-linked ampholytic polymers of the present invention may be used as thickeners in hair care compositions including, but not limited to the hair coloring or bleaching compositions described in co-filed U.S. Patent Application Ser. No. 60/834,867. These hair coloring or bleaching compositions may comprise at least 0.1 moles per liter (mol/L) of a source of: carbonate, carbamate, hydrogencarbonate or peroxymonocarbonate ions and mixtures thereof, at least one oxidizing agent, and at least one of the presently disclosed cross-linked ampholytic polymers. Ease of application to the hair may be achieved by providing the oxidizing composition and the dye compositions as so-called “thin-thin” type liquid compositions which are thickened upon mixing, or in which at least one of the components is provided as a thickened formulation which thickens the total composition upon mixing.

In some embodiments, the hair coloring or bleaching kits may comprise “thin-thin” type liquid compositions. These embodiments may comprise an individually packaged oxidizing liquid component comprising at least one source of hydrogen peroxide, and a second individually packaged liquid component comprising a source of: carbonate ions, carbamate ions or hydrogencarbonate ions and mixtures thereof, and at least one of the presently disclosed cross-linked ampholytic polymers. A liquid composition comprising at least 0.1 mol/L of a source of: carbonate ions, carbamate ions, hydrogencarbonate ions or peroxymonocarbonate ions and mixtures thereof, is produced upon mixing the two liquid components.

In further embodiments, the hair coloring or bleaching kits may be provided in which one of two components is provided as a thickened formulation which thickens the total composition upon mixing. These embodiments may comprise an individually packaged oxidizing liquid component comprising at least one source of hydrogen peroxide, and at least one of the cross-linked ampholytic polymers of the present invention. These embodiments further comprise an individually packaged second component comprising a source of: carbonate ions, carbamate ions or hydrogencarbonate ions and mixtures thereof. A liquid composition comprising at least 0.1 mol/L of a source of: carbonate ions, carbamate ions, hydrogencarbonate ions or peroxymonocarbonate ions and mixtures thereof, is produced upon mixing the two liquid components.

The cross-linked ampholytic polymers of the present invention may be used as PVMs in cleaning compositions, including but not limited to liquid dish detergents, liquid laundry detergents and liquid hard surface cleaners. In automatic liquid dishwashing detergent compositions, the polymers may be present from about 0.25% to about 10%, alternatively from about 0.5% to about 2%, by weight in the composition. The polymers may provide an apparent yield value to the compositions of from about 40 to about 800, or alternatively, from about 100 to about 600, dynes per square centimeter (dynes/cm²). The yield value is an indication of the shear stress at which the gel strength is exceeded and flow is initiated; yield value is measured as described in the Methods section infra.

Automatic liquid dishwashing detergent compositions may contain builders that can be used herein in any suitable amount including, but not limited to, at a level of from about 0% to about 30%, alternatively from about 0% to about 20%, by weight in the composition. Suitable builders are discussed in WO 02/68575.

The disclosed automatic liquid dishwashing detergent compositions may contain nonionic surfactant, at a level of from 0% to about 5%, alternatively from about 0.1% to about 2.5%, by weight of the composition. Suitable nonionic surfactants may include alkyl ethoxylates in non-chlorine bleach compositions. One non-limiting example of a non-chlorine bleach stable surfactant is SLF18® manufactured by BASF Corporation (Ludwigshafen, Germany). Alternatively, in chlorine bleach containing compositions, chlorine bleach stable low foaming surfactants may be used, and such surfactants can be present in a range of from about 0.1% to about 10% by weight of the composition; these surfactants are generally known to one skilled in the art. A non-limiting example of a chlorine bleach stable surfactant is Dowfax® anionic surfactant available from the Dow Chemical Company (Midland, Mich.).

Automatic liquid dishwashing compositions may further comprise known composition components such as enzymes, bleaching systems, zinc salts, dispersing polymers and solvents. Further components are discussed in co-pending U.S. patent application Ser. No. 11/149,817, filed Jun. 10, 2005.

The cross-linked ampholytic polymers of the present invention may be used in light-duty liquid dishwashing detergent compositions, which may have any suitable pH. The pH of these compositions may be adjusted using pH modifying ingredients known in the art. The compositions may have a pH of from 4 to 14, from 6 to 13, or from 6 to 10.

The light-duty liquid dishwashing detergent compositions may be thickened to have a viscosity of greater than about 0.5 Pa·s, when measured at 20° C.; in some embodiments, the viscosity of the composition may be from about 0.5 to about 1.1 Pa·s. The viscosity of light-duty liquid dishwashing detergent compositions is measured as described in the Methods section infra.

The light-duty liquid dishwashing detergent compositions of the present invention may comprise a surfactant system of from about 0.01% to about 50%, from about 1% to about 50%, from about 25% to about 50%, or from 30% to about 50%, by weight of the liquid detergent composition. Suitable surfactants include, but are not limited to: sulphate or sulphonate surfactants, and water-soluble salts or acids of C₁₀-C₁₄ alkyl or hydroxyalkyl. Suitable counterions include, but are not limited to: hydrogen, alkali metal cation or ammonium or substituted ammonium and sodium. Further suitable surfactants include, but are not limited to amphoteric surfactants such as amine oxides and betaines.

Further components for use in a light-duty liquid dishwashing detergent compositions may include: solvents, hydrotropes, enzymes, dyes, perfumes, diamines and suds boosting polymers, such as those disclosed in the following U.S. Pat. Nos. 5,990,065, 6,069,122 and 6,573,234.

The cross-linked ampholytic polymers of the present invention may be used as PVMs in a variety of personal care products, including, but not limited to moisturizers, conditioners, cleansers, sunscreens, anti-aging compounds, cosmetics (including, but not limited to, lipstick, foundation, rouges, creams, pencils, and/or mascara), and combinations thereof. The composition may be in a variety of forms, including but not limited to an emulsion, lotion, milk, liquid, solid, cream, gel, mousse, ointment, paste, serum, stick, spray, tonic, aerosol, foam, pencil, etc. The compositions of the present invention also may be in the form of shave prep products, including, for example, gels, foams, lotions, and creams; and include both aerosols and non-aerosols versions.

Absorbent Gelling Materials

The cross-linked ampholytic polymers of the present invention may be utilized as absorbent gelling materials (AGMs). AGMs are sometimes referred to in the art as “hydrogels”, “superabsorbent” materials or “hydrocolloid” materials. Upon contact with aqueous fluids, especially bodily fluids, AGMs may imbibe the fluids and form gels. AGMs are typically capable of absorbing large quantities of aqueous body fluids, and may further be capable of retaining such absorbed fluids under moderate pressures.

The cross-linked ampholytic polymers of the present invention may be used as AGMs in personal care absorbent articles; examples of known articles include, but are not limited to: sanitary napkins; pantiliners; diapers; and the like. Personal care absorbent articles are conventionally of a layered construction, each layer having a wearer-facing and a garment-facing surface. In general, the articles comprise a liquid permeable topsheet on the wearer-facing surface, a liquid barrier backsheet on the garment-facing surface, and an absorbent core disposed between the topsheet and the backsheet. In some embodiments, the polymers of the present invention may be located in the absorbent core in the form of granular discrete particles. In further embodiments, the polymers may be present in a fibrous or sheet form; the polymers may be dispersed homogeneously or non-homogeneously in a fibrous material. When the polymers are in contact with one or more bodily fluids such as menses or urine, the polymers may absorb the fluids thereby forming a gel, and may further retain the fluids.

Methods

All reagents are from Aldrich (St. Louis, Mo.) unless otherwise specified, and are used as received unless otherwise specified.

Tetraallylammonium chloride is prepared through quaternization of triallylamine from TCI Americas (Portland, Oreg.) with allyl chloride using typical quaternization procedures.

Hydrogen peroxide solution (12%) for stability testing is Clairoxide® 40 from Clairol, Inc. (Stamford, Conn.).

V-50® initiator is 2,2′-azobis(2-amidinopropane)dihydrochloride.

Span-80® is sorbitan monooleate.

Low conductivity ion-exchanged water from a Milli-Q® system from Millipore Inc. (Billerica, Mass.) is used for all methods.

### I. pH

The pHs of compositions are measured with an Orion 710A+ pH meter equipped with an Orion 8102BN combination electrode from Thermo Electron Corp. (Walthan, Mass.). The pH at which a cross-linked ampholytic polymer has a zero net charge (its isoelectric point) is determined by placing the polymer in solution and adjusting the solution's pH until the polymer collapses and settles out of solution. The pH at which the polymer settles out is the pH at which the polymer has a net charge of zero.

### II. NMR Spectra

NMR spectra are taken in acidified D₂O (0.6 g conc. HCl/100 g D₂O). The spectra are acquired on a Varian 500 MHz Unity Plus instrument (Palo Alto, Calif.) using standard parameters with a recycle delay of 30 seconds (sec).

### III. Rheology

Samples for rheology testing are prepared by mixing a 4-6% polymer dispersion in Clairoxide® 40 with a solution of 16 weight percent (wt %) ammonium carbonate and 14 wt % sodium glycinate at a 1:1 ratio. Rheology measurements are made on a TA instruments AR-1000 rheometer (New Castle, Del.) at 25° C. using its Peltier plate for temperature control. Measurements are made with either 25 (millimeter) mm parallel plates with the gap of 1000 microns or 40 mm 2° cone geometries. A continuous shear rate ramp experiment is performed from 0.5 to 1000 sec⁻¹ over 1 minute. Data is collected in log mode with 10 points per decade. Viscosity measurements at 1 and 900 sec⁻¹ are tabulated from the data.

The viscosity of the present light-duty dishwashing detergents is measured using a Brookfield viscometer model number LVDVII+, from Brookfield Engineering Labs, (Middleboro, Mass.), at 20° C. The spindle used for these measurements is S31 with the appropriate speed to measure products of different viscosities; e.g., 12 revolutions per minute (rpm) to measure products of viscosity greater than 1.0 Pa·s; 30 rpm to measure products with viscosities from 0.5 to 1.0 Pa·s; 60 rpm to measure products with viscosities less than 0.5 Pa·s.

### IV. Storage Stability

Samples for stability testing are added to hydrogen peroxide solution (12 wt % H₂O₂) with a pH of from about 3 to about 4, and stored at room temperature and at 40° C. Samples are prepared at 4 to 6 wt % to give an initial viscosity of 20-40 (Pascal seconds) Pa·s at 1 sec⁻¹ when mixed with an equal weight of the ammonium carbonate-sodium glycinate solution described above. Samples of the peroxide dispersions are removed periodically, mixed with an equal weight of salt solution, and the viscosity measured.

### V. Method of Making Polymers

The apparatuses for preparing polymers are composed of glass and Teflon®. No material is used that would introduce metal contamination. All dialysis is performed in cellulosic dialysis bags with a molecular weight cutoff of 3500 in ion-exchanged water. The concentration of polymer in the bag is 4-6 wt %.

The polymers may be prepared by polymerization techniques, including, but not limited to inverse suspension and solution polymerization as described in the Examples section infra.

### VI. Yield Value

Yield value is measured using a Brookfield RVT model viscometer from Brookfield Engineering Labs (Middleboro, Mass.) with a T-bar B spindle at 25° C. utilizing a Helipath drive upward during associated readings. The system is set to 0.5 rpm and a torque reading is taken for the composition to be tested after 30 seconds or after the system is stable. The system is stopped and the rpm is reset to 1.0 rpm. A torque reading is taken for the same composition after 30 sec or after the system is stable. Apparent viscosities are calculated from the torque readings using factors provided with the Brookfield viscometer. An apparent or Brookfield yield value is then calculated as: Brookfield Yield Value=(apparent viscosity at 0.5 rpm−apparent viscosity at 1 rpm)/100. This is the common method of calculation, published in CARBOPOL® literature and in other published references.

### EXAMPLES

### Comparative Example 1

### Solution Polymerization of AA, DADMAC and MBA

A flask is charged with water (19.50 g), distilled acrylic acid (3.08 g, 0.0427 moles), DADMAC solution (65 wt %, 10.63 g, 0.0427 moles), N,N-methylenebisacrylamide, i.e., MBA (0.0132 g, 0.09 millimoles (mmol), 0.10 mole percent (mol %) of monomer), and V-50® (0.116 g, 0.43 mmol, 0.5 mol % based on monomer). It is sparged with argon and heated to 65° C. for 20 hours in an oil bath. The polymer is discharged from the flask and dialyzed using 3.5 L of water changed 3 times. The final polymer solution is freeze-dried and the solid polymer is dried in the vacuum oven for 2 hours (h) at 50° C., then ground to a powder. Yield is 4.63 g (55 wt %). Analysis by proton NMR shows the polymer contains 72.5 mol % acrylic acid. A 4 wt % dispersion in water is thickened with a solution of 16 wt % ammonium carbonate and 14 wt % sodium glycinate and gives a viscosity of 30 Pa·s at 1 sec⁻¹. Samples for storage stability at 40° C. in hydrogen peroxide have a viscosity of 42 Pa·s initially, 20 Pa·s after 20 days, and 2 Pa·s after 85 days.

Without wishing to be bound by theory, it is believed that the thickened solution of Comparative Example 1 loses viscosity over time due to the cleavage of the cross-linked ampholytic polymer thickener at the cross-linking units through hydrolytic or oxidative degradation of the cross-linking unit. Similar behavior may also be observed for cross-linked ampholytic polymeric thickeners prepared with commonly used multi-functional monomers including: methylenebisacrylamide, pentaerythritol triallyl ether, and divinylbenzene. Cross-linked ampholytic polymers prepared with the multi-functional cross-linking monomers disclosed herein show improved stability by maintaining the ability to thicken (≧50% initial viscosity) after 90 days storage in Clairoxide® 40 at 40° C.

### Example 2

### Solution Polymerization of AA, DADMAC and DAU

A flask is charged with water (39.15 g), distilled acrylic acid (6.13 g, 0.085 moles), DADMAC solution (65 wt %, 21.16 g, 0.085 moles), 1,3-diallylurea (0.120 g, 0.85 mmol, 0.50 mol % of monomer), and V-50® (0.116 g, 0.43 mmol, 0.25 mol % based on monomer). It is sparged with argon for 30 minutes and heated to 65° C. for 20 hours in an oil bath. The polymer is discharged from the flask and dialyzed using 17 L of water changed 3 times. The final polymer solution is freeze-dried and the solid polymer is dried in the vacuum oven for 2 h at 50° C., then ground to a powder. Yield is 9.49 g (56 wt %). Analysis by proton NMR shows the polymer contains 72.1 mol % acrylic acid. A 4 wt % slurry in water is thickened with a solution of 16 wt % ammonium carbonate and 14 wt % sodium glycinate and gives a viscosity of 27 Pa·s at 1 sec⁻¹. Samples for storage stability at 40° C. in hydrogen peroxide have a viscosity of 27 Pa·s initially and 18 Pa·s after 88 days.

### Example 3

### Solution Polymerization of AA, DADMAC and DAAm

A flask is charged with water (39.12 g), distilled acrylic acid (6.15 g, 0.0853 moles), DADMAC solution (65 wt %, 21.23 g, 0.0853 moles), N,N-diallylacrylamide (0.052 g, 0.34 mmol, 0.20 mol % of monomer), and V-50® (0.116 g, 0.43 mmol, 0.25 mol % based on monomer It is sparged with argon and heated to 65° C. for 20 hours in an oil bath. The polymer is discharged from the flask and dialyzed using 17 L of water changed 4 times. The final polymer solution is freeze-dried and the solid polymer is dried in the vacuum oven for 2 h at 50° C., then ground to a powder. Yield is 9.70 g (57 wt %). Analysis by proton NMR shows the polymer contains 68.0 mol % acrylic acid. A 4 wt % slurry in water is thickened with a solution of 16 wt % ammonium carbonate and 14 wt % sodium glycinate and gives a viscosity of 38 Pa·s at 1 sec⁻. Samples for storage stability at 40° C. in hydrogen peroxide have a viscosity of 37 Pa·s initially and 38 Pa·s after 89 days.

### Example 4

### Solution Polymerization of AA, DADMAC and TAAC

A flask is charged with water (39.71 g), distilled acrylic acid (6.92 g, 0.0961 moles), DADMAC solution (65 wt %, 19.55 g, 0.0786 moles), tetraallylammonium chloride (0.372 g, 1.75 mmol, 1.0 mol % of monomer), and V-50® (0.120 g, 0.44 mmol, 0.25 mol % based on monomer). It is sparged with argon and heated to 65° C. for 20 hours in an oil bath. The polymer is discharged from the flask and dialyzed using 17 L of water changed 2 times. The final polymer solution is freeze-dried and the solid polymer is dried in the vacuum oven for 2 h at 50° C., then ground to a powder. Yield is 10.62 g (64 wt %). Analysis by proton NMR shows the polymer contains 70.8 mol % acrylic acid. A 4 wt % slurry in water is thickened with a solution of 16 wt % ammonium carbonate and 14 wt % sodium glycinate and gives a viscosity of 40 Pa·s at 1 sec⁻¹′. Samples for storage stability at 40° C. in hydrogen peroxide have a viscosity of 26 Pa·s initially and 17 Pa·s after 146 days.

### Example 5

### Solution Polymerization of AA, MAPTAC and DAU

A flask is charged with water (36.55 g), distilled acrylic acid (9.86 g, 0.137 moles), MAPTAC solution (50 wt %, 20.13 g, 0.0456 moles), 1,3-diallylurea (0.0767 g, 0.55 mmol, 0.30 mol % of monomer), and V-50® (0.0496 g, 0.18 mmol, 0.10 mol % based on monomer). It is sparged with argon for 30 minutes and heated to 65° C. for 5 hours in an oil bath. The polymer is discharged from the flask and dialyzed using 17 L of water changed 2×. The final polymer solution is freeze-dried and the solid polymer is dried in the vacuum oven for 2 h at 50° C., then ground to a powder. Analysis by proton NMR shows the polymer contains 74.4 mol % acrylic acid. A 4 wt % slurry in water is thickened with a solution of 16 wt % ammonium carbonate and 14 wt % sodium glycinate and gives a viscosity of 14 Pa·s at 1 sec⁻¹.

### Example 6

### Inverse Suspension Polymerization of AA, DADMAC and DAU

A 500 mL three-neck round bottom flask is charged with Span-80 (1.5 g) and cyclohexane (200 g) and is fitted with mechanical stirrer, a thermometer and a septum. Contents of the flask are sparged with argon and a head pressure of argon maintained thereafter. A separate flask is charged with water (39.15 g), distilled acrylic acid (6.13 g, 0.085 moles), DADMAC solution (65 wt %, 21.16 g, 0.085 moles), 1,3-diallylurea (0.120 g, 0.85 mmol, 0.50 mol % of monomer), and potassium persulfate (0.116 g, 0.43 mmol, 0.25 mol % based on monomer). It is cooled in an ice bath and sparged with argon. Agitation is set for 600 rpm and the monomer solution is added to the round bottom flask over 4 minutes. The flask is heated to 65° C. for 4 hours then cooled to 40° C. and aqueous ammonia (29%, 1.0 g, 0.017 moles) is added. The mixture is allowed to stir for at least 15 minutes after addition and then discharged to a 500 mL separatory funnel and the lower layer is withdrawn. The polymer is air-dried overnight. Analysis by proton NMR indicated a conversion of 54 wt %. The polymer is dispersed into water and dialyzed using 17 L of water changed 2 times. The final polymer solution is freeze-dried and the solid polymer is dried in the vacuum oven for 2 h at 50° C. Analysis by proton NMR shows the polymer contains 68.7 mol % acrylic acid. A 6 wt % slurry in water is thickened with a solution of 16 wt % ammonium carbonate and 14 wt % sodium glycinate and gives a viscosity of 42 Pa·s at 1 sec⁻¹.

### Example 7

### Inverse Suspension Polymerization of AA, MAPTAC and DAU

A 500 mL three-neck round bottom flask is charged with Span-80 (1.5 g) and cyclohexane (200 g) and is fitted with mechanical stirrer, a thermometer and a septum. Contents of the flask are sparged with argon and a head pressure of argon maintained thereafter. A separate flask is charged with water (36.53 g), distilled acrylic acid (9.88 g, 0.137 moles), filtered MAPTAC solution (50 wt %, 20.17 g, 0.0457 moles), 1,3-diallylurea (0.0384 g, 0.27 mmol, 0.15 mol % of monomer), and V-50® (0.0496 g, 0.18 mmol, 0.1 mol % based on monomer). It is cooled in an ice bath and sparged with argon. Agitation is set for 600 rpm and the monomer solution is added to the round bottom flask over 4 minutes. The flask is heated to 65° C. for 4 hours then cooled to 40° C. and aqueous ammonia (29%, 1.44 g, 0.0246 moles) added. The reaction is allowed to stir for at least 15 minutes after addition and then discharged to a 500 mL separatory funnel and the lower layer is withdrawn. The polymer is air-dried overnight then dried in the vacuum oven for 2 h at 50° C. Analysis by proton NMR shows the polymer contains 75.3 mol % acrylic acid. A 6 wt % slurry in water is thickened with a solution of 16 wt % ammonium carbonate and 14 wt % sodium glycinate and gives a viscosity of 14 Pa·s at 1 sec⁻¹.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A cross-linked ampholytic polymer comprising monomeric units derived from monomers selected from each of the following monomer types: polyfunctional cross-linking agents; anionic monomers; and cationic monomers;
wherein said cross-linked ampholytic polymer:
a. is Storage Stable for at least about 80 days at 40° C. in an aqueous dispersion comprising about 12 weight % of H₂O₂; and
b. has a net charge of 0 in an aqueous dispersion comprising a continuous phase at a pH within the inclusive range of from 2.0 to 6.0.

2. The cross-linked ampholytic polymer according to claim 1, wherein said polyfunctional cross-linking agents are selected from the group consisting of: 1,3-diallylurea; triallylurea; tetraallylurea; and monomers having formula (I):
N⁺(R₁R₂R₃R₄)A⁻ (I)
wherein:
a. R₁, R₂, R₃, and R₄ each have formula (II):
[(CH₂)ₙCH═CH₂] (II)
wherein n is an integer from 1 to 3 and is independently chosen for each of R₁, R₂, R₃, and R₄; and
b. A⁻ is an anion derived from organic or inorganic acids.

3. The cross-linked ampholytic polymer according to claim 2, wherein said monomer having formula (I) is tetraallylammonium chloride.

4. The cross-linked ampholytic polymer according to claim 1, wherein said anionic monomers have the formula (III):
R₅—CH═CR₆—CO—OH (III)
wherein:
a. R₅ is independently selected from the group consisting of: a hydrogen atom; a methyl radical; a COOH group; and a CH₂COOH group; and
b. R₆ is independently selected from the group consisting of: a hydrogen atom; a methyl radical; a CH₂COOH group; and a CH₂CH₂COOH group.

5. The cross-linked ampholytic polymer according to claim 4, wherein said anionic monomers are selected from the group consisting of: acrylic acid; methacrylic acid; maleic acid; fumaric acid; crotonic acid; and itaconic acid.

6. The cross-linked ampholytic polymer according to claim 5, wherein said anionic monomers are selected from the group consisting of: acrylic acid; and methacrylic acid.

7. The cross-linked ampholytic polymer according to claim 1, wherein said cationic monomers are selected from the group consisting of: diallyldimethylammonium salt; 3-methyl-1-vinylimidazolium salt; and monomers having formula (IV):
R₇—CH═CR₈—CO—Y—(CₘH₂ₘ)—N⁺(R₉R₁₀R₁₁)A⁻ (IV)
wherein:
(a) R₇ and R₈ are each independently selected from the group consisting of: a hydrogen atom, and a methyl radical;
(b) Y is selected from the group consisting of: an NH group; an NR₁₂ group, wherein R₁₂ is an alkyl group having from 1 to 6 carbon atoms; and an oxygen atom;
(c) m is an integer from 2 to 5;
(d) R₉, R₁₀ and R₁₁ are each independently selected from the group consisting of linear and branched alkyl radicals having from 1 to 6 carbon atoms; and
(e) A⁻ is an anion derived from organic or inorganic acids.

8. The cross-linked ampholytic polymer according to claim 7, wherein said cationic monomers are selected from the group consisting of: 3-acrylamidopropyltrimethylammonium chloride; diallyldimethylammonium chloride; [(3-methylacrylolyamino)propyl]trimethylammonium chloride; 3-methyl-1-vinylimidazolium chloride; [2-(acryloyloxy)ethyl]trimethylammonium chloride; and [2-(acryloyloxy)propyl]trimethylammonium chloride.

9. The cross-linked ampholytic polymer according to claim 1, wherein:
a. said polyfunctional cross-linking agent is 1,3-diallylurea;
b. said anionic monomer is acrylic acid; and
c. said cationic monomer is selected from the group consisting of:
diallyldimethylammonium chloride, and [(3-methylacrylolyamino)propyl]trimethylammonium chloride.

10. A composition comprising: the cross-linked ampholytic polymer according to claim 1, and oxidizing agent.

11. A cross-linked ampholytic polymer comprising monomeric units derived from monomers selected from each of the groups consisting of:
a. polyfunctional cross-linking agents selected from the group consisting of: 1,3-diallylurea; triallylurea; tetraallylurea; and monomers having formula (I):
N⁺(R₁R₂R₃R₄)A⁻ (I)
wherein:
1) R₁, R₂, R₃, and R₄ each have formula (II):
[(CH₂)ₙCH═CH₂] (II)
and further wherein n is an integer from 1 to 3 and is independently chosen for each of: R₁; R₂; R₃; and R₄; and
2) A⁻ is an anion derived from organic or inorganic acids
b. anionic monomers; and
c. cationic monomers.

12. The cross-linked ampholytic polymer according to claim 11, wherein said anionic monomers are selected from the group consisting of: acrylic acid; methacrylic acid; maleic acid; fumaric acid; crotonic acid; and itaconic acid.

13. The cross-linked ampholytic polymer according to claim 11, wherein said cationic monomers are selected from the group consisting of: 3-acrylamidopropyltrimethylammonium salt; diallyldimethylammonium salt; [(3-methylacrylolyamino)propyl]trimethylammonium salt; 3-methyl-1-vinylimidizolium salt; [2-(acryloyloxy)ethyl]trimethylammonium salt; and [2-(acryloyloxy)propyl]trimethylammonium salt.

14. The cross-linked ampholytic polymer according to claim 11, wherein said monomer having formula (I) is tetraallylammonium chloride.

15. The cross-linked ampholytic polymer according to claim 11, said polymer having a net charge of 0 in an aqueous dispersion having a viscosity and comprising a continuous phase at a pH within the inclusive range of from 2.0 to 6.0.

16. The cross-linked ampholytic polymer according to claim 15, such that when said polymer acquires a net negative or a net positive charge, said viscosity increases.

17. A composition comprising: the cross-linked ampholytic polymer according to claim 11 and oxidizing agent.

18. A method of increasing the viscosity of an aqueous solution, comprising the step of adding said cross-linked ampholytic polymer according to claim 11 to said aqueous solution.

19. A personal care absorbent article comprising cross-linked ampholytic polymer according to claim 11, such that when said cross-linked ampholytic polymer is exposed to at least one aqueous fluid, said cross-linked ampholytic polymer absorbs at least a portion of said aqueous fluid.

20. A cleansing composition selected from the group consisting of automatic liquid dishwashing detergent, light duty liquid dishwashing detergent, liquid laundry detergent and liquid hard surface cleaners, said composition comprising the cross-linked ampholytic polymers according to claim 11.
